(19) United States
(12) Patent Application Publication
(10) Pub. No.: US 2026/0077572 A1
(43) Pub. Date: Mar. 19, 2026

(54) Automotive Window Laminate Structure, Glass Sheet for Use in a Laminate, and Method for Producing an Automotive Window Laminate Structure

(71) Applicant: AUTOGLAS D & K B.V.., Alphen aan den Rijn (NL)

(72) Inventors: Bartholomeus Leonardus Marinus Borcherd Driehuis, Alphen aan den Rijn (NL); Timo Laurens Koolen, Alphen aan den Rijn (NL)

(21) Appl. No.: 19/104,011

(22) PCT Filed: Aug. 11, 2023
(86) PCT No.: PCT/NL2023/050423

§ 371 Date: Feb. 14, 2025

(30) Foreign Application Priority Data
Aug. 16, 2022 (NL) 2032757
Feb. 7, 2023 (NL) 2034103

(51) Int. Cl. B32B 17/10; B32B 1/00; B32B 37/24

(52) U.S. Cl. CPC B32B 17/10036; B32B 1/00; B32B 17/10155; B32B 17/10183; B32B 17/10201; B32B 17/1022; B32B 17/10238; B32B 17/10348; B32B 17/10431; B32B 17/10633; B32B 17/10935; B32B 37/24; B32B 2037/243; B32B 2250/40; B32B 2255/205; B32B 2264/1051; B32B 2264/107; B32B 2307/306; B32B 2307/71; B32B 2307/732; B32B 2311/08; B32B 2315/02; B32B 2398/20; B32B 2605/08

(57) ABSTRACT

The present invention is related to an automotive window laminate structure, including an inner glass sheet, and an outer glass sheet, said inner glass sheet and outer glass sheet situated parallel and mutually spaced apart, the inner glass sheet and outer glass sheet each including an inward facing surface and an outward facing surface, at least one thermoplastic laminated sheet structure, said thermoplastic laminated sheet structure substantially entirely placed between the outward facing surface of the inner glass sheet and the inward facing surface of the outer glass sheet, at least one reflective coating, in particular a heat and/or infrared reflective coating, said reflective coating provided on at least a portion of the inward facing surface of the outer glass sheet, and at least one ceramic band, stretching along at least a portion of the perimeter of the inward facing surface of the outer glass sheet. The invention is also related to a method for producing an automotive window laminate structure.

### CROSS-REFERENCE TO RELATED APPLICATIONS

This application is the United States national phase of International Patent Application No. PCT/NL2023/050423 filed Aug. 11, 2023, and claims priority to The Netherlands Patent Application No. 2032757 filed Aug. 16, 2022, and The Netherlands Patent Application No. 2034103 filed Feb. 7, 2023, the disclosures of which are hereby incorporated by reference in their entireties.

### BACKGROUND OF THE INVENTION

### Field of the Invention

The present invention is related to an automotive window laminate structure, the present invention is also related to a method for producing an automotive window laminate structure.

### Description of Related Art

Nowadays, functional layers comprise at least one active film layer like polymer-dispersed liquid-crystal (PDLC), Electro Chrome and other functional films like suspended-particle devices (SPD) are widely used in architectural glasses but are-more exceptionally-also used in the automotive industry. There are several reasons for that but in general, in the automotive industry, there is a higher demand in both safety regulations and quality issues. Active or functional layers like SPD, PDLC or Electro-chrome or Electrophorese films all have in common that they are build up from two opposing thermoplastic layers, at their mutually facing sides provided with a conductive coating, mostly an ITO coated PET, PEN, PC or PMMA layer, in between which two layers the active film layer is provided. All have in common that if an electric current flows from the first conductive layer through the liquid crystals to the second conductive layer, the crystals will be orientated aligned with the electric current causing a change in colour and/or light transmission and/or haze level. If such a layer is incorporated in a laminated glass structure it is called a functional layer. Incorporation is done by means of lamination process which commonly uses bonding layers and a frame layer.

These aforementioned active or functional films, but also more passive like functional films e.g., Photo-Chrome, Thermochromic films, Photopolymer films and Solar cell films, have in common that they are sensitive to high temperatures. High temperatures may occur when an automotive glass comprising said active or passive film is positioned under direct sunlight. Temperatures of the glass may rise to a level which may cause damage to the active and/or passive film. According to the temperature, the active and/or passive film incorporated in the window laminate may degrade and lose functionalities. Since a lot of automotive transport vehicles are parked outside for most of the time, they are being exposed to sunlight for most of the time. It is known that the UV light may also damage the active and/or passive film. However, these harmful UV rays may be at least partially filtered by one layer of glass, or a bonding layer as such. Clear glass is known for blocking at least UVC and UVB spectrum light, but may also filter a portion of the UVA spectrum light. Hence, the UV light as such does not impose a significant problem to the degradation of the active and/or passive films since the clear layer of glass may provide sufficient protection. However, although the UV spectrum as such may not be specifically a cause of degradation, it may indirectly contribute to the degradation of the active and/or passive film. In fact, a part of the sunlight is absorbed by the sheet of glass (or other component) and causes the sheet of glass to raise in temperature. The heat that is absorbed in the glass may cause degradation of the active and/or passive film of the automotive window laminate structure as such.

An automotive window laminated structure is especially prone to heating in the region of the obscuration band of the window laminate. Said obscuration band is mostly located around the perimeter of the window laminate, but also around the rear-view mirror area. Sensors and/or cameras may be located in the region of the obscuration band, where a cut-out may be provided for. Said obscuration band may be at least partially composed of silkscreen-and/or digitally printed ceramic enamel. These regions are in particular prone to heating due to the fact that the obscuration band is most frequently black, or close to black in colour. This region of the window laminate absorbs most of the sun radiation, and may due to absorbed heat reach temperatures of 90 degrees Celsius and above. The heating of the automotive window laminate is a serious issue for laminated automotive window laminates which comprise an active and/or passive film or layer. This is in particular the case if said active and/or passive film/layer stretches until underneath said obscuration band. High temperature gradients may occur due to the significantly higher temperatures in the glass at the region of the obscuration band. But also the high temperature as such may induce damage to the active and/or passive film/layer. High temperatures in e.g. a PDLC laminated stack may cause moisture, plasticisers, and other elements to be able to migrate faster. As a result, a reaction between migrated elements and the Liquid Crystals may occur and cause the Liquid Crystals to turn into a clear state. This phenomena may occur more frequently near the edge of the window laminate (i.e., the region of the obscuration band) because of the shortest distance between the bonding layer and active and/or passive film/layer. High temperatures accelerates this process.

This may be solved by not incorporating the active and/or passive film/layer underneath the obscuration band. However, it is desired to have the active layer stretch until underneath said obscuration band. For example, electrical connections may as such be hidden from sight, but also due to other aesthetical reasons such as hiding a cut line in the layer, or a protective tape. However, it can also be desired to block the complete light spectrum at parts of the active film/layer where a further improved anti-aging is desired, such as a flexible printed circuit to connect to an ITO or Silver coated layer of an active film/layer, such as; PDLC, SPD, EC. The most sensitive part of the film which is the edge may as such be hidden under the hottest area of an automotive glass.

Another known problem that these aforementioned (smart) active films/layers have a certain temperature band-width wherein they are able to switch with acceptable speeds. Hence, a so-called operational temperature window. In general at low temperatures the alignment of e.g., liquid crystals is slower and in extreme cold environments the switchable properties of such film/layer could even stop from being functional at all.

This can be solved by adding or increasing the concentration of additives like alcohol in the liquid crystal formula. This however has a known negative side effect, namely that the additives generally reduce the opaqueness of the film/layer at higher temperatures. This has to do with the behaviour of liquid crystals at elevated temperatures, which causes the liquid crystals to align with themselves. Though this may be counteracted by raising a switching power to e.g., 70 Volts square waves, this solution is not compatible with automotive solutions in view of the safety reasons. In the automotive industries a preferred use is made of a maximum 48 Volts and sinus waves as these have less interference with radio waves. AGP PCT/IB2018/059793 solves part of this problem by heating the glass, however this has a big disadvantage in that this consumes power, which is especially disadvantageous in electric vehicles. But secondly the most obvious resistive coating to power the heating would an Ag2 or Ag3 coating, which may typically be used on Face 3 of a heated windscreen. Face 2 however is more preferred to protect smart films, but not suitable to hide the power connections from the sight and has therefore rather big aesthetical problems.

There is thus a need for reducing the amount of heat that is absorbed into the window laminate, in particular in the area of an obscuration band. There are coatings available in the market which have an excellent infrared light reflecting property, which may allow to at least reflect a portion of the light to reduce the amount of heat absorbed. An example of such a coating may be a Silver sputtered coating, such as for example an AG or double Silver AG2, triple Silver AG3, up to AG4 and AG5 coatings. These coatings are typically sputtered onto the glass. Due to their infrared reflective properties, these coatings are being able to effectively reduce the amount of energy absorbed by the glass, bonding layers or other underlaying materials, as seen in direction from the sun going inwards to the vehicle (outside inwardly). However, it has turned out that these coatings are known for being incompatible with Ceramic enamel that forms the obscuration band. This is at least partially related to the high melting temperatures of the Ceramic enamels. Typically all Ceramic Enamels comprise fluxes, for lowering the melting point of the ceramic enamels to a level which is adjusted to the temperature at which the glass is processed. For tempered glass this is in the range of 500 to 800 degrees Celsius. For semi tempered or annealed laminated bended glass fluxes are added to the Ceramic enamel to lower the melting point to range of 500-650 degrees C. At these kind of temperatures some of the elements used for the silver coating can migrate and thus react with the elements used in the ceramic enamel. Moreover, it is also conceivable that elements of the Ceramic enamel migrate to the silver coating. This is undesired since it may damage the reflective properties or even damage the functional film/layer. Ceramic enamels may comprise additives to withstand acid rains, salted roads, extreme climates, but also comprise additives to adjust colours, or treated to be adjusted for manufacturing processes (e.g., press-bending, such that the bending tool touches the hot ceramic enamel and may not stick to the tool, requires additives in ceramic enamel to prevent from sticking to the tool or mated glass sheet during paired bending).

Said incompatibility of the Ceramic enamels to Silver sputtered coatings may be caused by migrating elements, in particular at high temperatures such as is the case during for example bending of glass, from the Ceramic enamel to the sputtered coating and attacking and/or reacting with the sputtered molecules material on the glass. This may cause a blurry or a sandblasted appearance of the glass, but also cause changes in colour to yellow, red, or greenish may occur in the (originally) black ceramic and/or silver coating. This may be caused by a change of thickness in the layers between the silver layers as these layers are adjusted to a certain thickness of filtering out a corresponding spectrum of the light, comparable to how a dichroic filter works. The colour of the silver coating may also change because the silver coating itself is altered. The silver coating can form compounds like AgCl of form Ag nanoparticles that absorb or diffract light. Silver also migrates through the stack and in some cases to the ceramic layer. These colour shifts may have variations which correspondent to a specific bending temperature of the glass. To reduce the loss of infrared reflective properties of the reflective layer, e.g., a dielectric ceramic, such as Si3N4 may be deposited between the ceramic enamel and the layer of silver coating.

Nowadays, if a Silver based sputtered infrared reflective IRR coating is used in a laminated automotive glass. Said silver coating (IRR coating) is commonly placed on Face 3, which is the first face (outwardly facing side) of a second glass (inner sheet of glass). As seen in a direction going from outside to the inside. Hence, Face 1 may be contemplated as the face of the outer glass sheet, which is in contact with the rain, Face 4 on the other hand is the face of the inner glass sheet facing into the cabin. Another solution to prevent or circumvent the incompatibility between the obscuration band and the infrared reflective coating, in particular the silver coating, is to not place the obscuration band (ceramic band) onto the reflective coating but to overlap/overcoat the reflective coating on top of the ceramic band, seen from outside inward. This in particular may be applied on face 2 (inner surface of the outer glass sheet), which causes the reflective coating to be applied onto the ceramic band. Although this causes changes in colour, this is not visible from the outside surface of the window since the reflective coating connects on an inside face of the glass. However, this solution is not suitable since it does not solve the problem of temperature differences since the reflective coating is situated behind the ceramic band (seen from outside in). In order to be able to withstand, higher heat or infrared loads, the reflective coating must be situated in front of the ceramic band, to prevent it from warming. Solutions according to the prior art however cause significant colour changes and incompatibilities as described above.

It is a first goal to provide for an automotive window laminate that is able to withstand a higher infrared or heat load without damaging the active and/or passive film or layer.

It is a second goal of the present invention to provide for an automotive window laminate comprising a silver-based coating that is less sensitive to corrosion.

It is a third goal of the present invention to provide an automotive window with increased heat reflective properties whilst maintaining a good appearance of the window exterior, in particular to prevent obscuration bands from decolouring.

It is a fourth goal of the present invention to provide an automotive window laminate which allows for a better protection of the functional layer.

### SUMMARY OF THE INVENTION

The present invention thereto proposes an automotive window laminate structure, comprising an inner glass sheet, and an outer glass sheet, said inner glass sheet and outer glass sheet situated substantially parallel and mutually spaced apart, the inner glass sheet and outer glass sheet each comprising an inward facing surface and an outward facing surface, preferably at least one thermoplastic laminated sheet structure, said thermoplastic laminated sheet structure at least partially, preferably substantially entirely placed between the outward facing surface of the inner glass sheet and the inward facing surface of the outer glass sheet, at least one reflective coating, in particular a heat and/or infrared reflective coating, said reflective coating provided on at least a portion of the inward facing surface of the outer glass sheet, at least one ceramic band, stretching along at least a portion of the perimeter of the inward facing surface of the outer glass sheet, preferably wherein the at least one reflective coating and the at least one ceramic band at least partially overlap, and optionally wherein at least a portion of the at least one ceramic band stretches beyond the perimeter of the at least one reflective coating. In particular, the at least one ceramic band is provided, preferably directly, onto the at least one reflective coating.

In respect of the present invention, the inward facing surface of the outer glass sheet and the inner glass sheet may otherwise be referred to as Face 2 and Face 4 respectively. Also, the outward facing surface of the outer glass sheet and the inner glass sheet may otherwise be referred to as Face 1 and Face 3 respectively. The ceramic band may also be referred to as an obscuration band or layer. By applying the heat and/or infrared reflective coating onto at least a portion, preferably entire Face 2 an optimal heat reflection may be realized. That is, where according to prior art the reflective layer is located on e.g., Face 3 or at least below (seen from outside inward) the ceramic band, heat may penetrate the automotive window laminate further. Also, where according to the prior art a reflective coating is applied on Face 2, this typically overlaps the obscuration band (if at all) only at the fade out portion. However, at the fade out portion, any changes in colour due to incompatibility may hardly be observed by the eye. Also, here it is only known to provide the reflective coating on the inward facing side of the obscuration band, which still does not reflect infrared or heat prior to reaching the obscuration or ceramic band. By applying the reflective coating, according to the present invention, on substantially entire Face 2 at least a part of the heat or infrared light is blocked or reflected already before it has been absorbed by the ceramic band. This may prevent that the ceramic band reaches temperatures that will accelerate the degradation of functional layers. This may as such significantly reduce the infrared and/or heat load that reaches the functional film/layer of the automotive window laminate structure, since the reflective coating is located prior to the sunlight reaches said film or layer. The amount of energy that is absorbed by the obscuration band may as such be reduced, since the reflective coating is located outside (seen from outside inward) of the ceramic band. This is in particular of benefit if sensitive functional films or layers are incorporated in the window laminate. At least in a region where the reflective coating and ceramic band overlap. This may be understood as the ceramic band being provided below (seen in a direction from outside inward) of the reflective coating. As such, at least a part of sunlight travelling from outside inwardly into the window laminate is blocked or reflected, at least partially, by the reflective coating prior to hitting (and being absorbed as heat) by the ceramic band. Hence, it is preferred that the reflective coating is applied directly on the inward facing surface of the outer glass sheet (Face 2). Preferably, at least a portion of the ceramic band, in particular said overlap with the reflective coating, is applied onto the reflective coating, such that (seen from outside inward), the ceramic band is located below the reflective coating. Preferably, at least a portion of the ceramic band is applied directly onto the inward facing surface of the outer glass sheet. In particular, it is preferred that the portion of the ceramic band that stretches beyond the perimeter of the at least one reflective coating is applied directly on Face 2 of the window laminate, hence on the inward facing surface of the outer glass sheet. As such, at least that portion of the ceramic band may locally seal the reflective coating. This may be caused by the property of the ceramic band to be more impermeable compared to the reflective coating. That is, the ceramic band thus overlaps the reflective coating and extends beyond it along at least a portion of the perimeter, and as such locally encapsulates the reflective coating, in particular from a lateral side. The overlap or seal may also reduce the number of different colour areas which contributes to a better esthetical appearance. Alternatively it may be stated that said ceramic band stretches to a portion of the inward facing surface of the outer glass sheet that is free of reflective coating. It is also conceivable that the reflective coating covers essentially the entire inward facing surface of the outer glass sheet (Face 2). In such an instance, extending beyond the perimeter may be understood as the ceramic band stretching toward a side edge of the (outer) glass sheet, and hence as such also locally sealing said reflective coating. The difference being that the seal is established on the side surface of the glass sheet. However, the ceramic band may be applied relatively thin (between 10 to 100 micron), and hence have a relatively low impact on the dimensions.

The at least one ceramic band may in the present invention in particular be understood as a solid ceramic band. Here, ceramic band may be understood to be a solid and/or consecutive band and/or surface. It is for example known in automotive glazing to provide a fade out pattern adjacent to an inner circumference of the (solid) ceramic band. However this fade out pattern is not understood according to the present invention as the ceramic band. The fade out is considered as having a mainly aesthetic purpose and does not impose the same compatibility issues and temperature issues with the ceramic band according to the invention. Thus, where overlap is described with a ceramic band, this is to be understood as an overlap with the solid portion of the ceramic band. Where reference is made to a ceramic band, i.e., the at least one ceramic band, or the second ceramic band, or third ceramic band, also reference could be made to the at least one ceramic layer, the at least one second ceramic layer, or the at least one third ceramic layer. In this respect. Band is preferably understood as a layer of material stretching along a certain path of the glass sheet, with a certain thickness, typically corresponding to a width of commonly used obscuration bands.

The present invention is in particular related to the use of ceramic bands, in particular to enamel ceramic bands, in contrast to the use of painted obscuration bands. Said painted obscuration bands are typically applied after bending of the glass, and are formed by regular paint or by tinting a thermoplastic layer, such as a bonding layer. Although this may allow to provide a reflective coating on Face 2, this does not provide the same advantages. For example, painted obscuration bands are significantly more prone compared to ceramic obscuration bands. Also painted obscuration bands cannot be applied prior to firing or bending the glass, since this would cause the paint to burn and besides, printing may be easier and more accurate when done on flat materials. Where in this application reference is made to a ceramic band, this may also be replaced with a ceramic enamel bend.

This allows the present invention to provide for an automotive window laminate structure that is able to withstand higher heat or infrared loads that hit the window. This is due to the reflective coating being provided on Face 2 of the window laminate, which prevents the ceramic band from reaching temperatures that cause migration of elements and/or particles and that cause damage to the functional layer. Moreover, the present invention also provides for a better seal of the silver-based infrared reflective coating (if applied) since the ceramic band possesses good sealing properties, allowing the ceramic band to seal said silver coating since it extends beyond said coating in order to provide for an (preferably impermeable) seal. Additionally, the present invention allows for a better appearance of the window exterior since the ceramic band does not react with the reflective coating, at least partially due to the ceramic band extending beyond the perimeter of the reflective coating. The automotive window laminate may in particular be a curved automotive window laminate.

Preferably, although optionally, the aforementioned overlap between the reflective coating and the portion of the ceramic band is formed by in particular the second ceramic band and/or the third ceramic band, if applied. If the second and/or third ceramic band, if applied, overlap with the reflective coating, and stretch at least partially beyond said reflective coating and hence form at least a portion of the seal, it is not necessarily required that the at least one ceramic band, in particular the black ceramic band, overlaps and stretches beyond the at least one reflective coating. Hence this may yield an automotive window laminate structure, comprising an inner glass sheet, and an outer glass sheet, said inner glass sheet and outer glass sheet situated parallel and mutually spaced apart, the inner glass sheet and outer glass sheet each comprising an inward facing surface and an outward facing surface, at least one thermoplastic laminated sheet structure, said thermoplastic laminated sheet structure substantially entirely placed between the outward facing surface of the inner glass sheet and the inward facing surface of the outer glass sheet, at least one reflective coating, in particular a heat and/or infrared reflective coating, said reflective coating provided on at least a portion of the inward facing surface of the outer glass sheet, at least one ceramic band, stretching along at least a portion, preferably a portion of the perimeter, of the inward facing surface of the outer glass sheet, further comprising at least one second ceramic band. Preferably the at least one second ceramic band is different compared to the at least one ceramic band. Optionally at least one third ceramic band may be applied. In this respect at least one of the at least one second and/or the at least one third ceramic band is preferably arranged between the at least one ceramic band and the reflective coating. Optionally, at least one of the ceramic bands at least partially overlaps and stretches beyond the perimeter of said reflective coating. Where in this application reference is made to ceramic band, this may also be referred to as a ceramic layer or a ceramic coating. The word band may be understood as a ceramic layer having a certain width, not necessarily a constant width. The at least one reflective coating and the at least one ceramic band and/or the at least one second ceramic band and/or the at least one third ceramic band at least partially overlap, and wherein at least a portion of the at least one ceramic band stretches at least partially beyond the perimeter of the at least one reflective coating. However it has been found that applying a substantially transparent and/or translucent second ceramic band between the reflective coating and the at least one ceramic band significantly reduces the colour changes in the obscuration band as seen from the outside. Thus, in achieving a better appearance of the window, it is not necessary to have one of the ceramic bands extend beyond the perimeter of the reflective coating. But the mere use of transparent or translucent second ceramic layer and/or band may achieve a similar effect. It is conceivable that the transparent ceramic layer, in particular the transparent ceramic enamels are at least partially formed by an overglaze. It was surprisingly found that an overglaze which may be used as an overglaze for potteries and roof tiles, but also known for embedding particles in anti-skid glass is suitable to be used as a transparent ceramic band to the solution to the present invention. Thus, where reference is made to the transparent ceramic layer, this may be partially formed by an overglaze layer. Throughout this application, the second ceramic band may otherwise be referred to as intermediate ceramic band and/or intermediate ceramic layer. The seal of a first ceramic band may also contribute to a more homogeneous and better esthetical appearance.

Since the present invention provides for an improved reflective property, it also allows for increased stability of the liquid crystal formula. That is, reducing the range of the high temperature to which the automotive window laminate is exposed, also reduces the problems of the properties of the liquid crystal formula. Hence, the liquid crystal formula may be adapted such that it switches at lower temperature, eliminating the need for a heating system, which is undesired since it is expensive and consumes power. And also eliminating the need for increasing the amount of additives, which affect the aesthetic appearance of the window. In fact it would even help to reduce the temperature of a the car interior if parked in the sun, and is therefore saves even more energy since the power required for cooling shall be lower.

Preferably, an edge along at least a portion of the perimeter of at least one of the inner glass sheet and/or outer glass sheet is rounded and/or bevelled and/or chamfered. In this respect, the bevelled edge may be at least partially upwardly inclined and/or outwardly inclined. Additionally, the bevel may be provided on either the inward facing surface and/or the outward facing surface of the inner glass sheet and/or outer glass sheet. Preferably, the edge of each of the inner glass sheet and outer glass sheet is at least partially provided with a rounded edge, preferably along the entire perimeter thereof. This may provide for a better distribution of stresses in the glass sheets. In this respect, it is preferred that the ceramic band stretches along at least a part of the perimeter of the outer glass sheet until a portion of the rounded and/or bevelled portion. That is, the edges of the ceramic band may be partially bended and/or folded along the edge of the glass sheet, in particular such as to encapsulate the reflective coating in order to provide for a seal. It is preferred that said rounded and/or bevelled and/or chamfered portion is essentially free of reflective coating.

As such, providing the ceramic band to stretch until the bevelled or rounded or chamfered portion may provide that the ceramic band stretches beyond said reflective coating and as such provide for a seal thereof. Sealing the reflective coating may prevent that moisture penetrates said coating and damages it but may also contribute to a better aesthetical appearance. Hence it is preferred that the at least one ceramic band at least partially overlaps with said rounded and/or bevelled portion. Rounding or bevelling or chamfering may be applied after applying the reflective coating of the window laminate. The process of applying rounding or bevelling or chamfering also provides an edge of the glass sheet that is free of coating. Hence, it may ensure to provide for a portion of the glass sheet that is free of reflective coating and as such allow the ceramic band to form a seal or to a part of a seal. Preferably, the edge is a flat polished edge and/or a bevelled edge and/or a (full, demi, or half) bullnose edge and/or a pencil polish edge and/or (single, double or triple) o'gee edge and/or boston profile edge. Preferably, the edge of the glass is at least partially asymmetrically. Preferably, at least the outer glass sheet is at least asymmetrically rounded and/or bevelled and/or machined. In particular more material is removed from an inward facing side of said outer glass sheet. In particular wherein the asymmetrically machined edge locally removes essentially all reflective coating on an inwardly facing side of the outer glass sheet. This allows to obtain a rounded or machined edge, which is typically preferred, as well as the removal of reflective coating in a single step. Preferably, about 2.5 mm of reflective coating is removed.

Preferably, the automotive window laminate structure comprises at least one second ceramic band, preferably stretching along at least a portion of the perimeter of the inward facing surface of the outer glass sheet. The second ceramic band allows for an increased compatibility between the reflective coating and found to surprisingly increase the ability to withstand heat without affecting the appearance of the ceramic band. In particular if the second ceramic band is at least partially translucent and/or transparent, in particular a translucent and/or transparent ceramic enamel, it was found that a great seal may be provided of the reflective coating reducing the corrosion. Is was surprisingly discovered that using a transparent and/or translucent coating and/or ceramic band allows for an improved seal of the reflective coating. Since the transparent and/or translucent second ceramic band comprises less additives less incompatibility is observed. It is conceivable that the second ceramic band is at least partially arranged between the at least one ceramic band and the at least one reflective coating. This in particular has contributed to a more constant appearance of the window. It is known that the reflective coating may, at elevated temperature such as during bending of the window laminate, affect the colour of the ceramic band. In particular if the at least one ceramic band is composed partially out of black ceramic enamel. If a second ceramic band is provided at least partially between the reflective coating and the at least one ceramic bend, this change in colour of said at least one ceramic band is significantly reduced. Optionally, the second ceramic band is at least partially composed of Jetver Ultra 8S001_MHM, commercially sold by Tecglass. The result is a deeper black obscuration band, seen from the outside of the window. The tones of black may be measured using any illuminative spectrophotometer, in particular an D65/10 illuminate spectrophotometer can be used for measuring the colour of the ceramic band. Preferably, the second ceramic band comprises less metal elements compared to the at least one ceramic band.

Normally, the metal elements present in the dark ceramic enamel cause at least a part of the incompatibility between the ceramic band and the reflective coating. Moreover, other additives may also contribute to the incompatibility. By providing a transparent and/or translucent second ceramic band, in particular to the reflective coating, and optionally an opaque third ceramic band this may be reduced and/or eliminated. This allows for choosing a wider range of compatible materials. Preferably, the second ceramic band is composed out of transparent ceramic enamel, in particular enamel ink, a particularly suitable example is 7T001_MMH Jetver Transparent commercially sold by Tecglass.

In a non-limitative experiment it is shown that if in an AG2 coated soda lime glass (commercially sold as Iris from AGC) the Ceramic black enamel, constituting the at least one ceramic band, (commercially sold as 1A004_MMM Jetver Black automotive from Tecglass) is printed in direct contact with the reflective coating, and this is dried and cured at 520 degrees Celsius, which is typically a rather low temperature to bend glass, the result is that the ceramic enamel print seen from outside (trough glass on the ceramic enamel) looks Purple. This is because of the reaction at high temperatures between the elements of the reflective coating and the ceramic band. The appearance is unevenly mat. If the temperature of firing is brought up to 590 degrees Celsius, which is typically a high temperature to bend glass. The observed colour of these sample changes to Amber/gold. But also Green colours can be observed in mid-range bending temperatures. As glasses and especially the black ceramic enamel on it, are not homogenous fired during glass bending processes this would leads to undesired colour differences on a single glass, but also the mat appearance is unwanted. The combination of AGC Iris Ag2 coating with 1A004_MMM Ceramic black enamel would normally be considered as incompatible with each other. In aforementioned example an D65/10 illuminate spectrophotometer was used to measure the CieLab colour of the glass after the low temperature bending cycle and as a result L*14.58 a*+0.85 b*+4.34 value was measured. The Cielab colour space is a widely accepted method for the definition of darkness of colours as well as the position of a colour on a 3 dimensional axis colour space in automotive sector. The axis L* defines the depth and 0 refers to black and 100 refers to white. a* negative stands for Green and positive for Red and b* negative refers to Blue and positive to Yellow and a*b* both 0 refers to colour neutral. To which L represent colour depth axis and a-b defines the position in the horizontal axes of the colour scale. If the same sample is provided with an intermediate transparent ceramic band (commercially sold 7T001_MMH Jetver Transparent from Tecglass), which thus forms the second ceramic band, and then printed and cured under the same conditions, as a result a deep black shiny appearance is observed by looking from the outside of the glass (trough glass onto the ceramic band) and a CieLab colour measurement with the same spectrophotometer results in L*3.01 a*+0.41 b*+0.94 meaning L is deep Black and a-b much more colour neutral.

If on the same sample the AG2 coating was locally deleted by means of a laser, and provided with black ceramic band without having the transparent second ceramic band, this would represent for a reference to the influence of the Ag2 reflective coating. For this result the colour measurement of L*2.22 a*+0.17 b*−0.42 shows that the reference measurement is very close to the measurement of the sample with a transparent intermediate ceramic enamel (second ceramic band) in both colour depth as on colour horizontal axes. The combination of AGC Iris Ag2 coating with 1A004_MMM Ceramic black enamel with a transparent second ceramic band can thus be marked as a very good compatibility to each other.

It is noted that this experiment is non-limitative to substantiate the advantageous effect of the second ceramic band. Similar examples could yield similar result and are herewith not excluded from the scope.

In yet two other non-limitative experimental glass samples a reflective coating of two different types is provided. First an Ag2 double Silver coating (commercial sold as IRR colour box from Guardian) marked as S1 and an Ag3 triple silver coating (commercial sold as Sunguard SNX70HT from Guardian) marked as S2. The same black ceramic enamel Jetver 1a004-MMM was provided partly direct on the silver reflective coating and partly on the transparent second ceramic band, 7T001_MMH and then dried and cured at 560 degrees Celsius. The colour inspection, using the spectrophotometer was executed to provide the difference in colour depth. As the samples were provided with the at least one ceramic band partly on top of the Silver coating and partly on top of the second ceramic band, the difference in colour can be accurately measured on the same sample. The results below shows that significant changes in both the colour depth as well on the horizontal axes were realized if the ceramic band, in particular the black, is printed on the second transparent ceramic band. S1 Ag2 glass black ceramic band, in particular black enamel, printed directly on the reflective coating: L*22.85 a*−0.38b*+2.38. S1 Ag2 black ceramic band, in particular black enamel, printed on the second ceramic band, in particular the transparent second ceramic band: L*2.92 a*+0.15 b*+0.32. S2 Ag3 black ceramic band, in particular black enamel, added directly on the reflective coating: L*19.29 a*−2.07 b*+5.20. S2 Ag3 black ceramic band, in particular black enamel, printed on the second ceramic band, in particular the transparent second ceramic band: L*6.33 a*−0.71 b*+1.96. Although the samples without the second transparent ceramic band can be marked as compatible, the aesthetic appearance shows a big difference. This can be beneficial if neighbouring glasses on a vehicle, such as a car, have no reflective coating so black print remains unaffected from any reactions during glass bending. Printing the black ceramic band on the second transparent ceramic band thus yields even colour depth compared to neighbouring glasses without such a reflective coating, which is beneficial.

It is furthermore known that incompatibility between the at least one ceramic band and the reflective coating, in particular in the case of a silver based reflective coating, the resistivity may be adversely affected by the incompatibility. The resistivity of the reflective coating may be measured in Ohm/square and can be measured using a Stratometer G Fw. Rel. 1.01.8. from manufacturer Nagy Instruments, in particular built in November 2010. It was measured that using a Saint Gobain Climacoat 4Ag as a reflective coating, which was subsequently provided with a Jetver 8S001_MHM transparent ceramic enamel as a second ceramic band, which was dried and overprinted with a Jetver 1A004_MMM black ceramic enamel as the at least one ceramic band, and fired to 560 degrees Celsius provided the following results in terms of resistivity: a resistivity measurement shows 0.646 Ohm/Square on the area where the second ceramic band and the at least one ceramic band are provided and a resistivity of 0.626 Ohm/Square on the area where no ceramic is provided. Hence, a very good maintenance of resistivity properties is observed.

It is also conceivable that the laminate structure comprises at least one third ceramic band, preferably stretching along at least a portion of the perimeter of the inward facing surface of the outer glass sheet. In particular wherein the third ceramic band is an opaque ceramic enamel, more in particular wherein the third ceramic band is arranged between the at least one second ceramic band, if applied, and the at least one ceramic band. By providing a third layer preferably an opaque ceramic band, even better or other results can be achieved in terms of colour depth. Apart from providing a second and third ceramic band, it is also possible to provide a mixed second ceramic band. Preferably, the mixed second ceramic band comprising for example 70% (by volume and/or by weight) of transparent ceramic and 30% (by volume and/or by weight) of opaque ceramic. Although such a mixed second ceramic band achieves slightly less results in terms of colour depth compared to providing both a second ceramic band and a third ceramic band, a thinner result may be obtained. Also a single layer may yield the same advantages.

The second ceramic band and/or the third ceramic band may be applied in combination with the sealing of the reflective coating according to the invention, but may also be applicable in general, hence, to achieve this advantage it is not required that the at least one reflective coating and the at least one ceramic band at least partially overlap, and wherein at least a portion of the at least one ceramic band stretches beyond the perimeter of the at least one reflective coating. In this aspect the invention is furthermore related to an automotive glass sheet, in particular an outer glass sheet of an automotive window laminate, said automotive glass sheet comprising an inward facing surface and an outward facing surface, said automotive glass sheet provided with at least one reflective coating, in particular a heat and/or infrared reflective coating, said reflective coating provided on at least a portion of the inward facing surface of the glass sheet, further comprising at least one second ceramic band and/or second ceramic layer, said second ceramic band and/or second ceramic layer provided onto the at least one reflective coating, the glass sheet optionally further comprising at least one ceramic band, in particular stretching along at least a portion of the perimeter of the inward facing surface of the glass sheet, in particular wherein the second ceramic band and/or second ceramic layer is at least partially transparent and/or translucent. Preferably, the at least one ceramic band is at least partially opaque, preferably black. It is imaginable that the second ceramic band and/or the second ceramic layer and/or the at least one ceramic band are ceramic enamels. Preferably, the at least one ceramic band is applied, in particular directly, on top of the second ceramic band and/or second ceramic layer. Preferably, the second ceramic band and/or second ceramic layer is, in particular directly, applied on the at least one reflective coating. It is imaginable that the second ceramic band and/or second ceramic layer covers essentially the entire at least one reflective coating. This in particular allows the second ceramic band and/or second ceramic layer to protect the at least one reflective coating which for example in case of a low-E coating may be required to protect the reflective properties of the glass. The compatibility with the Low-E coating was in particular observed in the following non-limitative example. A glass sheet provided with a low-E coating available under the name Silverguard nRG clear by Guardian was provided with a second ceramic band, which was in particular transparent. At least one Ceramic band, in particular a black ceramic band, was subsequently provided on both the second ceramic band and partially on the reflective coating formed by Silverguard nRG clear. Using the same measurement tools as described above a value of L*28,06 a*−0.71 b*−0.42 was obtained in the area where the ceramic band was provided onto the reflective coating, whereas a value of L*2.89 a*0.33 b*−0.29 was observed where the at least one ceramic band was provided onto the at least one second ceramic band fired on 550 degrees Celsius. The benefits of the automotive window laminate as explained above apply mutatis mutandis to the automotive glass sheet. For example the deeper black colour of the ceramic, the compatibility between the ceramic and the reflective coating. This automotive glass sheet may be used in the automotive window laminate according to the present invention, in particular as an outer glass sheet. Different aspects and corresponding benefits of the automotive window laminate may mutatis mutandis be applied on the automotive glass sheet, without in doing so, requiring other aspects to be incorporated. It is also conceivable the automotive glass sheet is used as a side window for a vehicle, in particular a car. These aspects provide particular advantages of deep black obscuration bands, or for sealing a reflective coating. For example side windows in doors, which are typically allowed for moving up and down. Said upward and downward movement of the glass sheet may cause reflective coatings from tearing and wearing due to contact with the inner door strip and/or a weather strip. Providing the at least one second ceramic band may as such provide protection to the reflective coating. However it is also conceivable that contact between coating and the rollers and/or mould parts during bending and/or tempering of the glass can be avoided. When a reflective coating is applied on a glass sheet, this for example may be a monolithic tempered glass sheet. The colour spectrum which is reflected or mirrored differs to the spectrum that passes through the glass and/or is absorbed. This is at least partially caused by the coating properties as more of the red spectrum is reflected. Therefore, the reflected light will have a different colour. This is also the case if a ceramic band, in particular a ceramic enamel, is applied to the coating. The reflected colour may be adjusted by the thickness of the dielectric layers of the coating. However, since the ceramic band also has influence on the colour, a translucent ceramic enamel, which is a ceramic enamel which is not completely opaque, may be used to alter both colour and reflective colour.

According to a different embodiment, the at least one ceramic band stretches at least its own thickness in length beyond the reflective coating. It is also conceivable that the at least one ceramic band stretches at least the thickness of the reflective coating in length beyond the reflective coating. This may ensure a sufficiently applied seal in respect of the at least one reflective coating. Said reflective coating may be applied in a thickness of about 100 nm-500 nm, preferably around 200 nm. By allowing the ceramic band to stretch beyond the reflective coating in at least its own thickness it is ensured that the ceramic band seals the reflective coating. That is due to the fact that the ceramic layer is typically thicker compared to the reflective coating. Hence, as such it is ensured that in fact the ceramic band is adhered to a portion of the outer sheet of glass which is free of reflective coating to provide for the needed seal. Preferably the at least one ceramic band has an average thickness situated between about 10 micron and 60 micron, preferably about 30 micron. This thickness has proven to provide for sufficiently low light transmittance in case of a black ceramic band. It is conceivable that a thicker ceramic band may be applied, having a greater average thickness, in case a different colour ceramic band is applied. A thickness of up to three times the aforementioned thickness may be conceivable when applying a different ceramic colour. Hence, the at least one ceramic band may stretch at least 10 micron beyond the reflective coating. This is significantly shorter compared to conventional techniques, where a bonding layer provides for sealing the reflective coating. Typically, a bonding layer seal requires to stretch at least 6 mm, but preferably 15 mm beyond the coating. Hence the present invention allows the reflective coating to stretch further to the edge of the glass sheet, and hence having a larger effective usable surface area and an improved aesthetic appearance.

Preferably, the at least one reflective coating is an infrared and/or heat reflective coating. Infrared and heat are two of the dominant factors that accelerate degradation of the automotive window laminate. To this end it is preferred that said reflective coating is at least configured for reflecting heat and/or infrared radiation to prevent heating of the ceramic band. It is imaginable that the reflective coating is applied on the entire inward facing surface of the outer glass sheet. Entire inward facing surface may be understood as the entire plane up till the rounded or bevelled edge (if applied). By applying the reflective coating on the entire inward facing surface of the outer glass sheet (Face 2) an even reflection of heat and/or infrared radiation may be achieved. Preferably, said reflective coating ensures the ceramic band does not exceed a temperature of about 70 degrees Celsius, plus or minus 10 degrees Celsius, preferably plus or minus 5 degrees Celsius. This may have a big influence of the expected lifetime of the automotive window laminate, in particular of the functional film or layer. Since the ceramic band typically heats up significantly more that the remainder of the window laminate, in particular the central portion, a temperature gradient may as such be reduced. Where, according to the prior art the ceramic band may reach temperatures in excess of 90 degrees Celsius, where the remainder of the window laminate may only reach temperatures of typically maximum 60 degrees Celsius, a 30 degrees Celsius gradient is present where the ceramic band is provided. The present invention may reduce said gradient to only a 10 degrees Celsius gradient. This may reduce induced stresses in the laminate, in particular in the transition region where the ceramic band is applied, which is beneficial for the lifespan of the window laminate as such. Typically two ways of applying a reflective coating are usable. First of all pyrolytic coatings, which may be applied in the float glass process while glass is still hot from the molten state. In this state glass may be pulled over a bath of liquid Tin, before annealing coatings can be sprayed onto the hot surface to fuse with the glass layer. Pyrolytic coatings have Infrared reflective and emissivity reducing (low-e) properties which are relatively hard and durable. The fused coatings are not sensitive for most outside ambient conditions and are known for being compatible with some Ceramic enamels fused on their coating. A non-limitative example of an Ceramic enamel that may be used for the present invention is available by the Fenzi group, such as type XLM54S-IRP01. As an alternative method magnetron sputtered coatings may be applied, which may otherwise be referred to as Physical vapor deposition (PVD). PVD coatings are applied only after the glass is produced, by means of a vacuum chamber and electric charged cathode shooting atoms into a plasma surrounded magnetic field onto the glass surface. Sputtered coatings comprise metal and dielectric layers forming an infrared reflective layer, which is soft and has lower durability in terms of permeability in outside ambient conditions, such as moisture. Especially when elements are used that are prone to contact with moisture, such as Silver (ag). Sputtered coatings are also known for being incompatible to black ceramic enamels fused on their coating. To this end, it is preferred that the at least one reflective coating is preferably free of zinc and/or zinc Oxide (ZnO). By applying the reflective coating that is free of zinc and/or zinc oxide, it may be easier to apply the ceramic band to the reflective coating. As such, incompatibility risks are being reduced. Instead of zinc and/or zinc oxides, titanium and/or titanium (di)oxides may be used to fulfil the functionality. The benefit of sealing the reflective coating with the ceramic band are maintained.

It is preferred that the at least one ceramic band stretches beyond the at least one reflective coating along the entire perimeter of the at least one reflective coating. As such, essentially the entire at least one reflective coating is sealed by means of the ceramic band, which is of great benefit for maintaining the properties of the functional layer. Also, by sealing essentially the entire reflective coating by means of the ceramic band, the need for applying a specific seal in said region is eliminated. Hence, cost may be reduced in production. Additionally, a reduced weight of the automotive window laminate may be achieved since there is no need for providing an alternative seal by means of different or additional materials. According to the present invention, it is not required to provide for edge deletion of the reflective coating. That is, the reflective coating may optionally stretch to the perimeter of the glass sheet. Since it is not required for the edge of the reflective coating to be removed locally, an entire production step may be eliminated, which may allow for a faster process, and also a simpler window laminate. Preferably, the at least one ceramic band seals, preferably impermeably seals, the at least one reflective coating, in particular the perimeter thereof.

According to a preferred embodiment the at least one reflective coating comprises silver particles, such as AgCl, and/or Ag nanoparticles, in particular at least one Ag1 coating. Yet, it is also conceivable that an Ag2, Ag3, Ag4 coating is provided as a reflective coating. In this respect Agx coating may be contemplated as a silver-based coating wherein “x” may refer to the number of passes by a sputter machine. It is also conceivable that a dielectric coating is provided locally on the silver-based coating. Said dielectric coating may for example be a dielectric ceramic, such as Si3N4. preferably, said dielectric coating is provided between the silver based reflective coating and the ceramic band. This may resolve compatibility issues arising between the reflective coating and the ceramic band. It is conceivable that if the reflective coating comprises metal particles, in particular silver particles, the coating may block or obstruct radio waves, to this end a radio wave port may locally be provided into the reflective coating. Such a radio wave port may be in the size of about 100 mm by 60 mm or larger with a shaped grid of 0.1 mm and a pitch of 1 mm depending on the desired frequency to pass through. Preferably, said radio wave port is at least partially covered by the second ceramic band and/or third ceramic band, if applied, or the at least one ceramic band. To this end the same compatibility was observed.

Preferably, the at least one ceramic band is in particular a ceramic enamel band. Preferably said ceramic band, in particular said ceramic enamel comprises at least one additive chosen from the group consisting of: aluminium, bismuth, boron, calcium, lead, lithium, magnesium, silicon, titanium, sodium, potassium, tin, oxides, zinc, zirconium, nickel-chromium, iron-oxide, manganese-oxide, chromium-oxides, and/or boron-trioxide. Preferably, zinc and zinc oxides, and zirconium are not used. Preferably, instead of zinc and/or zinc oxides, titanium and/or titanium (di)oxides may be used to fulfil the functionality. Additives for colouring the Ceramic may be chosen from oxides containing elements like; aluminium, bismuth, boron, calcium, Gold, lead, lithium, magnesium, silicon, titanium, sodium, Platinum potassium, tin, or oxides of the aforementioned. Preferably, the ceramic band is free of bismuth. Preferably, said ceramic band is free of zinc and zinc oxides, and zirconium. The black pigment may comprise NiCr, Fe oxides, Mn oxides, Cr oxides, and fluxes like Boron-Trioxide may be added to lower melting point.

There are some particular examples of compatible reflective coating and ceramic bands. Preferably, when the ceramic band, in particular the ceramic enamel comprises bismuth, the reflective coating is essentially free of zinc. A particular composition of aforementioned situation wherein the ceramic band comprises bismuth, the reflective coating—seen from outside inwardly—comprises a first layer of silicon nitride (Si3N4), in particular 410 Å, a second layer of Nickel (Ni), in particular 7 Å, a third layer of Silver (Ag), in particular 100 Å, a fourth layer of Nickel (Ni), in particular 7 Å, a fifth layer of silicon nitride (Si3N4), in particular 900 Å, a sixth layer of Nickel (Ni), in particular 7 Å, an seventh layer of Silver (Ag), in particular 100 Å, an eighth layer of Nickel (Ni), in particular 7 Å, a nineth layer silicon nitride (Si3N4), in particular 410 A. Subsequently, a ceramic band which may thus comprise bismuth, may be embodied by a ceramic that is known as Johnson Matthey L6029-IR. This particular, non-limitative embodiment has proven to be compatible for use in the present invention.

Yet, as an alternative, when the reflective coating comprises zinc, the ceramic band is preferably essentially free of bismuth. In this respect, any zinc comprising reflective coating may be applied, wherein particular compatible ceramic bands may at least partially, preferably entirely be embodied by for example AGC Super Iris Ag3 coating and/or for example Jetlux F5496128M Platinum glass/ceramic band.

Preferably the thermoplastic laminated sheet structure comprises at least one functional layer, having an upper and lower surface, preferably wherein the at least one functional layer comprises at least two thermoplastic layers, and at least one film layer, in particular a functional film or layer, between the at least two thermoplastic layers, and at least two bonding layers, wherein the at least two bonding layers at least partially cover the upper and lower surfaces of the at least one functional layer.

The present invention is furthermore related to a glass sheet for use in an automotive window laminate according to the present invention. The present invention is also related to a method for producing an automotive window laminate structure, preferably according to the present invention, comprising the steps of:
a) providing an inner glass sheet and an outer glass sheet, said inner glass sheet and outer glass sheet each comprising an inward facing surface and an outward facing surface,
b) providing at least one reflective coating onto at least a portion of the inward facing surface of the outer glass sheet,
c) sealing at least a portion of the perimeter of the at least one reflective coating,
d) providing a thermoplastic laminated sheet structure between the inner glass sheet and outer glass sheets.

Preferably, the method comprises a step of: providing at least one second ceramic band, preferably wherein the at least one second ceramic band is a transparent and/or translucent ceramic band, applied, preferably directly applied, onto the at least one reflective coating, in particular wherein said sealing of step c) is sealed by applying the second ceramic band. It is conceivable that the method comprises a step of: providing at least one third ceramic band, preferably wherein the at least one second ceramic band is an opaque ceramic band, applied, preferably directly applied, onto the at least one second ceramic band.

According to a preferred embodiment, during step c), said portion of the perimeter is sealed through step e) providing at least one ceramic band along at least a portion of the perimeter of the inward facing surface of the outer glass sheet, preferably wherein said at least one ceramic band is applied onto the at least one second ceramic band, more preferably wherein said at least one ceramic band is applied onto the at least one third ceramic band. Preferably, wherein during step e), at least a part of the at least one ceramic band and/or at least a part of the at least one second ceramic band and/or at least a part of the at least one third ceramic band, overlaps the reflective coating applied during step b), and wherein at least a portion of the at least one ceramic band and/or at least a part of the at least one second ceramic band and/or at least a part of the at least one third ceramic band stretches beyond the perimeter of the at least one reflective coating applied during step b). It is conceivable that, during step c) the entire perimeter of the at least one reflective coating is sealed, in particular impermeably sealed. Optionally, the method comprises the step of: f) providing a bevel and/or rounding on at least a portion of the edge of at least one of the inner glass sheet and/or outer glass sheet. Preferably, the second or third ceramic band are applied by printing a wet layer of about 10-100 microns thick. This depends on the printing method as the amount of solvent with digital printing typically requires thicker wet layers compared to silkscreen printing. Applying the at least one ceramic band and/or at least one second ceramic band and/or at least one third ceramic band can be done by means of printing. It is conceivable that printing of the various bands is done after curing, drying or firing the previous layer, but it is also conceivable that the ceramic bands are applied on top of each other when still, at least partially, wet.

The benefits as disclosed in relation to the automotive window laminate structure are also applicable with respect to the method for producing an automotive window laminate structure and glass sheet, and are herewith incorporated by reference with respect thereto.

Preferred embodiments of the present invention are set out in the following non-limitative clauses.
1. Automotive window laminate structure, comprising:
   an outer glass sheet, and optionally an inner glass sheet, preferably said inner glass sheet and outer glass sheet situated parallel and mutually spaced apart, the inner glass sheet and outer glass sheet each comprising an inward facing surface and an outward facing surface,
   optionally at least one thermoplastic laminated sheet structure, said thermoplastic laminated sheet structure substantially entirely placed between the outward facing surface of the inner glass sheet and the inward facing surface of the outer glass sheet,
   at least one reflective coating, in particular a heat and/or infrared reflective coating, said reflective coating provided on at least a portion of the inward facing surface of the outer glass sheet,
   at least one ceramic band, stretching along at least a portion of the perimeter of the inward facing surface of the outer glass sheet,
      preferably wherein the at least one reflective coating and the at least one ceramic band at least partially overlap, and optionally wherein at least a portion of the at least one ceramic band stretches beyond the perimeter of the at least one reflective coating.
2. Automotive window laminate structure according to clause 1, wherein an edge along at least a portion of the perimeter of at least one of the inner glass sheet and/or outer glass sheet is rounded and/or bevelled, or wherein an edge along at least a portion of the perimeter of at least one of the inner glass sheet and/or outer glass sheet is machined and/or modified.
3. Automotive window laminate structure according to clause 2, wherein said rounded and/or bevelled portion is essentially free of reflective coating.
4. Automotive window laminate structure according to clause 2 or 3, wherein the at least one ceramic band at least partially overlaps with said rounded and/or bevelled portion.
5. Automotive window laminate structure according to any of the preceding clauses, wherein the laminate structure comprises at least one second ceramic band, preferably stretching along at least a portion of the perimeter of the inward facing surface of the outer glass sheet.
6. Automotive window laminate structure according to clause 5, wherein the second ceramic band is a translucent and/or transparent ceramic band, in particular enamel, in particular wherein the second ceramic band is at least partially arranged between the at least one ceramic band and the at least one reflective coating.
7. Automotive window laminate structure according to any of the clauses 5 or 6, wherein the laminate structure comprises at least one third ceramic band, preferably stretching along at least a portion of the perimeter of the inward facing surface of the outer glass sheet.
8. Automotive window laminate structure according to clause 7, wherein the third ceramic band is an opaque ceramic enamel, in particular wherein the third ceramic band is arranged between the at least one second ceramic band, if applied, and the at least one ceramic band.
9. Automotive window laminate structure according to any of the preceding clauses, wherein the at least one ceramic band stretches at least its own thickness in length beyond the reflective coating.
10. Automotive window laminate structure according to any of the preceding clauses, wherein the at least one reflective coating is an infrared and/or heat reflective coating.
11. Automotive window laminate structure according to any of the preceding clauses, wherein the reflective coating is applied on the entire inward facing surface of the outer glass sheet.
12. Automotive window laminate structure according to any of the preceding clauses, wherein the at least one ceramic band stretches beyond the at least one reflective coating along the entire perimeter of the at least one reflective coating.
13. Automotive window laminate structure according to any of the preceding clauses, wherein the at least one ceramic band seals, preferably impermeably seals, the at least one reflective coating, in particular the perimeter thereof.
14. Automotive window laminate structure according to any of the preceding clauses, wherein the at least one reflective coating comprises silver particles, such as AgCl, and/or Ag nanoparticles.
15. Automotive window laminate structure according to any of the preceding clauses, wherein the at least one ceramic band is in particular a ceramic enamel band, comprising at least one additive chosen from the group consisting of: aluminium, boron, calcium, Gold, lead, lithium, magnesium, silicon, titanium, sodium, Platinum, potassium, tin, oxides, nickel-chromium, iron-oxide, manganese-oxide, chromium-oxides, and/or boron-trioxide.
16. Automotive window laminate structure according to any of the preceding clauses, wherein the at least one ceramic band has an average total thickness situated between about 10 micron and 60 micron, preferably about 30 micron.
17. Automotive window laminate structure according to any of the preceding clauses, wherein the thermoplastic laminated sheet structure comprising;
   at least one functional layer, having an upper and lower surface, preferably wherein the at least one functional layer comprises at least two thermoplastic layers, and at least one film layer between the at least two thermoplastic layers, and;
   at least two bonding layers, wherein the at least two bonding layers at least partially cover the upper and lower surfaces of the at least one functional layer.
18. Glass sheet for use in an automotive window laminate according to any of the clauses 1-17.
19. Method for producing an automotive window laminate structure, preferably according to any of the clauses 1-16, comprising the steps of:
   a) providing an outer glass sheet and optionally an inner glass sheet, said inner glass sheet and outer glass sheet each comprising an inward facing surface and an outward facing surface,
   b) providing at least one reflective coating onto at least a portion of the inward facing surface of the outer glass sheet,
   c) optionally sealing at least a portion of the perimeter of the at least one reflective coating,
   d) optionally providing a thermoplastic laminated sheet structure between the inner glass sheet and outer glass sheets.
20. Method according to clause 19, wherein the method comprises a step of:
   providing at least one second ceramic band, preferably wherein the at least one second ceramic band is a transparent and/or translucent ceramic band, applied, preferably directly applied, onto the at least one reflective coating, in particular wherein said sealing of step c) is sealed by applying the second ceramic band.
21. Method according to clause 20, wherein the method comprises a step of:
   providing at least one third ceramic band, preferably wherein the at least one second ceramic band is an opaque ceramic band, applied, preferably directly applied, onto the at least one second ceramic band.
22. Method according to any of the clauses 19-21, wherein during step c), said portion of the perimeter is sealed through step e)
   providing at least one ceramic band along at least a portion of the perimeter of the inward facing surface of the outer glass sheet, preferably wherein said at least one ceramic band is applied onto the at least one second ceramic band, more preferably wherein said at least one ceramic band is applied onto the at least one third ceramic band.
23. Method according to any of the clauses 20-22, wherein during step e), at least a part of the at least one ceramic band and/or at least a part of the at least one second ceramic band and/or at least a part of the at least one third ceramic band, overlaps the reflective coating applied during step b), and wherein at least a portion of the at least one ceramic band and/or at least a part of the at least one second ceramic band and/or at least a part of the at least one third ceramic band stretches beyond the perimeter of the at least one reflective coating applied during step b).
24. Method according to any of the clauses 19-23, wherein during step c) the entire perimeter of the at least one reflective coating is sealed, in particular impermeably sealed.
25. Method according to any of the clauses 19-24, wherein the method comprises the step of:
   f) providing a bevel and/or rounding on at least a portion of the edge of at least one of the inner glass sheet and/or outer glass sheet.

### BRIEF DESCRIPTION OF THE DRAWINGS

The terms Fig., Figs., Figure, and Figures are used interchangeably in the specification to refer to the corresponding figures in the drawings.

The present invention will hereinafter be further elucidated based on the following drawings, wherein:

FIG. 1 shows a cross sectional view of an automotive window laminate structure according to an embodiment of the present invention;

FIG. 2 shows a portion of the automotive window laminate according to a different embodiment;

FIG. 3a-3e show a part of the production process of an automotive window laminate structure according to the invention; and

FIGS. 4a-4e show another embodiment of the present invention.

### DESCRIPTION OF THE INVENTION

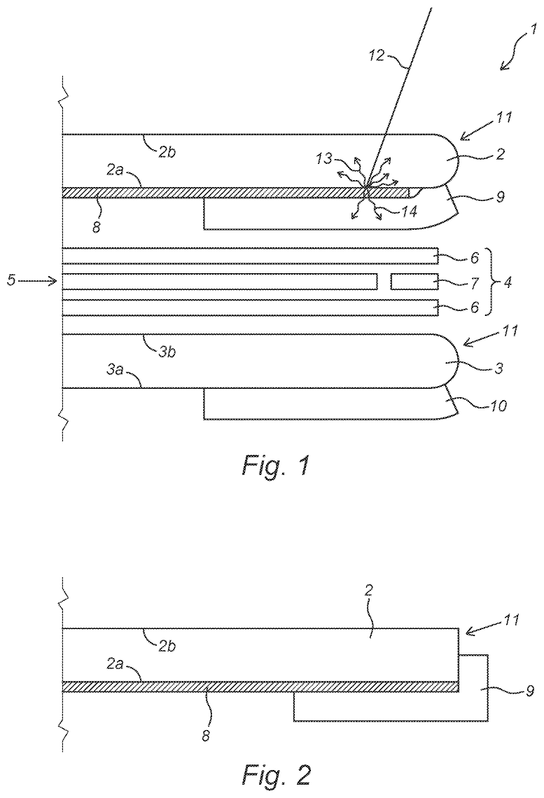

FIG. 1 shows a first embodiment of an automotive window laminate 1 according to the present invention. For illustrative purposes merely a portion of the automotive window laminate 1 is shown. The cross sections as shown in this figure allows to elaborate more on the inventive concept of the present invention. As it is the goal of the present invention to provide for an automotive window laminate 1 which is able to reduce the amount of heat absorbed by the window, the embodiment shown provides for an inventive solution. The figure shows the cross section comprising an outer glass sheet 2, and an inner glass sheet 3, which outer glass sheet 2 and inner glass sheet 3 are mutually parallel and situated at a distance of one another. Each of the outer glass sheet 2 and inner glass sheet comprises respectively an inward facing surface 2a, 3a, and an outward facing surface 2b, 3b. In this respect, the outward facing surface 2b of the outer glass sheet 2 may be referred to as Face 1 of the window laminate, and the inward facing surface 2a of the outer glass sheet 2 as Face 2. Similarly the outward facing surface 3b of the inner glass sheet 3 may be referred to as Face 3 of the window laminate, and the inward facing surface 3a of the inner glass sheet 3 as Face 4. Between said outer glass sheet 2 and inner glass sheet 3 a thermoplastic laminated sheet structure 4 is provided. Said thermoplastic laminated sheet structure 4 comprises at least one functional layer 5 preferably comprising at least one film layer such as a polymer-dispersed liquid-crystal device, and/or a suspended-particle devices, and/or an electrochromic device, and/or micro-blinds, and/or passive functional layer. Said film layer may be deposited between two thermoplastic layers, wherein said thermoplastic layers may at least partially be composed out of polyethylene terephthalate (PET), or polyethylene naphthalate (PEN), or Tri Acetate Cellulose (TAC). It is conceivable that at least one side of at least one thermoplastic layer is provided with a conductive coating, preferably Indium Tin Oxide (ITO). Around at least a portion of the perimeter of the functional layer 5 a frame layer 7 is provided. Said frame layer 7 may be at least partially be formed out of a separate material, but may also be formed by an inactive portion of the functional layer 5. Said frame layer 7 is configured to provide for a proper seal of the functional layer 5. This is especially preferred in case of thicker types of functional layers 5. On either side of the functional layer 5 and the frame layer 7 a bonding layer 6 is applied. Said bonding layers 6 allow to adhere the functional film to the sheets of glass 2, 3. In order to provide for a better heat and/or infrared radiation resistance, the present invention is provided with a reflective coating 8. Said reflective coating 8 preferably comprises Silver. Preferably, the at least one reflective coating comprises silver particles, such as AgCl, and/or Ag nanoparticles, in particular at least one Ag1 coating. Yet, it is also conceivable that an Ag2, Ag3, Ag4 coating is provided as a reflective coating. Silver based coatings are one of the preferred options since they have a decent infrared reflective property. The inventive concept according to the present invention lies in the fact that said reflective coating 8 is provided on Face 2 of the automotive window laminate 1, hence on the inward facing surface 2a of the outer glass sheet 2. As such, a beam of sunlight and/or infrared radiation 12 hitting the outer sheet of glass 2 passes through said outer glass sheet 2, and is to a significant extend reflected by the reflective coating 8. Hence, the incoming sunlight and/or infrared radiation 12 is largely reflected back in outwardly reflections 13. Only a small fraction of the incoming sunlight and/or infrared 12, an inward reflection 14, is able to pass through the reflective coating 8. As such, only the inward reflections 14 are able to heat up components situated below said reflective coating 8. In particular a ceramic band 9 that is provided around a portion of the perimeter of at least the outer glass sheet 2 will as a result of said reflective coating 8 heat up less. This is to a great extent due to the fact that said reflective coating 8 is situated (seen in a direction from outwards to inwards) above the ceramic band 9. Said reflective band may cover a portion of the thermoplastic laminated sheet structure 4, in particular an area comprising an electronic connection and/or a frame layer 7. It is desired to reduce the amount of heat that is absorbed and/or transferred into the interior portion of the window laminate 1. Said interior portion may be seen as the thermoplastic laminate 4 and the ceramic band 9. Said ceramic band 9 may in particular be prone to higher temperatures since it is often black in colour. Hence, if none of the incoming rays of sunlight and/or incoming infrared is blocked, it may absorb a significant portion as heat, raising its temperature. Said ceramic band 9 may, if no reflective coating 8 is provided on Face 2, reach temperatures of above 90 degrees Celsius. The present invention may cause a reduction of the maximum temperature to around 60 to 70 degrees Celsius, under the same conditions. The ceramic band 9 stretches beyond the reflective coating 8, until a portion of the edge 11 of the glass sheet 2, 3 that is essentially free of reflective coating. This allows the ceramic band to locally prevent moisture from coming into contact with the reflective coating 8. Preferably, said ceramic band 9 as such seals the reflective coating 8. The ceramic band 9 preferably stretches beyond the reflective coating 8 for at least 10 micron-60, hence only a small fraction is sufficient to seal the reflective coating 8. This may be due to the properties of the ceramic band. In this figure the edges 11 of the outer glass sheet 2 and inner glass sheet 3 are rounded.

FIG. 2 shows an alternative of a glass sheet 2, 3 according to the present invention. In this particular figure an example of the outer glass sheet 2 is shown, but said shape may also be used in respect of the inner glass sheet 3. However, in order to provide further insight as to how to apply the inventive concept for a different glass edge shape the outer glass sheet 2 is shown here. The edge 11 of glass sheet 2 in this figure is straight, and may form a substantially perpendicular angle with respect to the outward facing surface 2b and the inward facing surface 2a of the outer glass sheet 2. A reflective coating 8 is provided on the inward facing surface 2a of the glass sheet 2. In this embodiment, the reflective coating 8 is applied on essentially the entire inward facing surface 2a of the glass sheet 2. This may e.g. be done prior to further processing of the glass sheet 2. It is also imaginable that large sheets of glass are provided with a reflective coating 8, such as any coating according to the invention, wherein after application of the reflective coating 8 the large sheets of glass are cut into a sheet to be used. This may yield that, as shown in this figure, the reflective coating 8 stretches all the way to the edge 11 of the glass sheet 2 since this reflects the cut line. However, it still remains possible to prevent the reflective coating 8 to be in contact with an external environment, and hence with moisture. In this respect, a ceramic band 9 may be provided which stretches until the edge 11 of the glass sheet 2. Since the ceramic band 9 preferably stretches beyond the reflective coating 8 in at least its own thickness, and due to the fact that the reflective coating is normally an order of magnitude thinner, it may be ensured that the ceramic band 9 indeed stretches until a portion of the edge 11 of the glass sheet 2 that is free of reflective coating 8. As such, the portion of the ceramic band 9 that is adhered to the portion of the edge 11 that is free of reflective coating may seal the reflective coating 8. This may contribute to the life span of the window laminate 1.

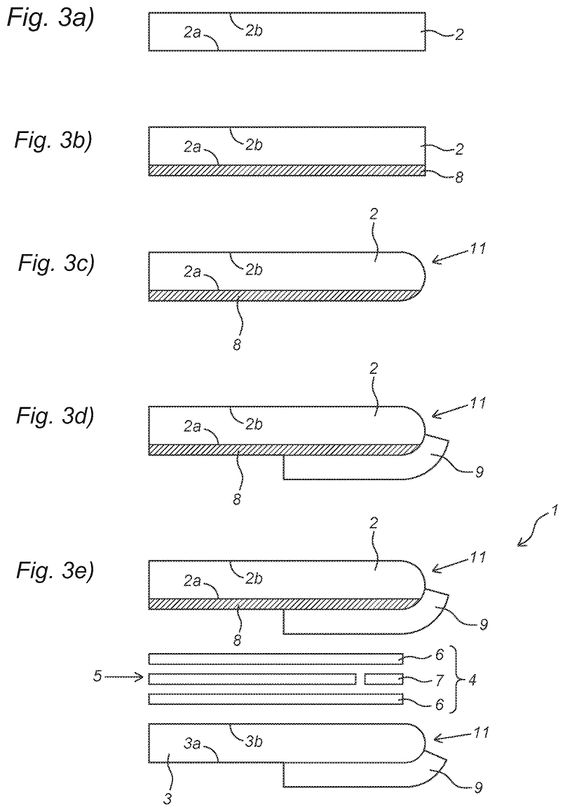

FIGS. 3a-3e show a part of the method according to the present invention. In this respect, FIG. 3a shows a first step wherein a sheet of glass 2 is provided. Although in FIG. 3a an outer glass sheet is shown, it is also conceivable that at this step an inner glass sheet 3 is provided for. During the subsequent step, shown in FIG. 3b a coating 8 is applied, in particular a reflective coating 8 is applied on an inward facing surface 2a of the outer glass sheet 2. The reflective coating 8 is applied on substantially the entire inward facing surface 2a of the outer glass sheet 2. As such, the entire window laminate may have good reflective properties. In the step shown in FIG. 3c an edge 11 of the outer glass sheet 2 is rounded. Rounding the edge 11 of the glass sheet 2 may provide for better distribution of stresses in the glass sheet 2. These stresses may for example be introduced during a bending process. For illustrative purposes, the glass sheet and window laminate shown in FIG. 3 are shown in horizontal orientation, although it is conceivable that the sheet 2 or laminate 1 is slightly curved. During step shown in FIG. 3d a ceramic band 9 is provided onto the outer glass sheet 2. Said ceramic band 9 is in particular applied such as to overlap partially with said reflective coating 8, but also extending beyond said reflective coating 8 onto a portion of the edge 11 of the glass sheet 2 that is essentially free of reflective coating. Where it is mentioned in this application that a portion of the glass sheet 2 is free of reflective coating, this may be understood as said portion being free or made free of reflective coating. It is however preferred to eliminate the step of removing said coating 8 locally since this reduces production times. In this respect, the ceramic band 9 as shown in FIG. 3d stretches until a part of the rounded edge 11 that is free of reflective coating 8. This allows to seal off the reflective coating 8 from moisture by means of the ceramic band. Thus, FIGS. 3a-3d show the subsequent steps of preparing an outer glass sheet 2 according to the present invention, wherein FIG. 3e shows an assembled automotive window laminate 1 according to an embodiment of the present invention. Below (seen in direction outward to inward) the outer glass sheet 2 a thermoplastic laminated sheet structure 4 is provided. Said thermoplastic laminated sheet structure 4 comprises two bonding layer 6 and a functional film 5 as described in the present application. Optionally, an inward facing surface 3 of the inner glass sheet 3 may also be provided with a ceramic band 9. As such, the connection and frame layer 7 of the thermoplastic laminated sheet structure 4 that are present along the perimeter of the sheet structure 4 may be hidden from sight of a driver.

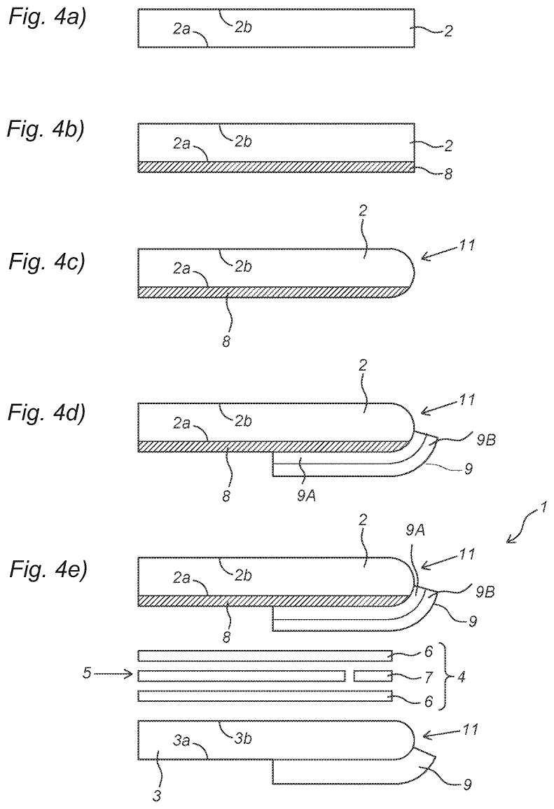

FIGS. 4a-4e show a part of yet another embodiment according to the present invention. In this respect, FIG. 4a shows a first step wherein a sheet of glass 2 is provided. Although in FIG. 4a an outer glass sheet is shown, it is also conceivable that at this step an inner glass sheet 3 is provided for. During the subsequent step, shown in FIG. 4b a coating 8 is applied, in particular a reflective coating 8 is applied on an inward facing surface 2a of the outer glass sheet 2. The reflective coating 8 is applied on substantially the entire inward facing surface 2a of the outer glass sheet 2. As such, the entire window laminate may have good reflective properties. In the step shown in FIG. 4c an edge 11 of the outer glass sheet 2 is rounded. Rounding the edge 11 of the glass sheet 2 may provide for better distribution of stresses in the glass sheet 2. These stresses may for example be introduced during a bending process. For illustrative purposes, the glass sheet and window laminate shown in FIG. 4 are shown in horizontal orientation, although it is conceivable that the sheet 2 or laminate 1 is slightly curved. During step shown in FIG. 4d a ceramic band 9 is provided onto the outer glass sheet 2. Said ceramic band 9 comprises at least one second ceramic band 9A, and the at least one ceramic band 9B. In this respect, the at least one second ceramic band 9A is provided onto the reflective coating 8, and preferably is substantially transparent or translucent, for example transparent ceramic enamel 9A. The at least one second ceramic band 9A may optionally stretch over substantially the entire surface of the reflective coating 8. The at least one ceramic band 9B may be in particular a black ceramic band 9B, such as to form the typical black edge of a window of a vehicle. The at least one ceramic band 9B as such would determine the daylight opening of the window. By applying the at least one second ceramic band 9A, which is different from the at least one ceramic band 9B a more aesthetically pleasing appearance may be achieved. Not only that it also contributes to the overall compatibility. In fact the black ceramic band 9B is typically not very compatible with the reflective coating 8, which may be in part resolved by the at least one second ceramic band 9A. This allows to achieve both a better reflective property as well as a better overall aesthetical appearance of the window, since the black will typically be darker and also more shiny, as seen from the outside of the window (i.e., from the side 2b). Said ceramic band 9 is in particular applied such as to overlap partially with said reflective coating 8, but also extending beyond said reflective coating 8 onto a portion of the edge 11 of the glass sheet 2 that is essentially free of reflective coating, although this is not required when the improved aesthetic is the only goal. Where it is mentioned in this application that a portion of the glass sheet 2 is free of reflective coating, this may be understood as said portion being free or made free of reflective coating. It is however preferred to eliminate the step of removing said coating 8 locally since this reduces production times. In this respect, the ceramic band 9 as shown in FIG. 4d stretches until a part of the rounded edge 11 that is free of reflective coating 8. This allows to seal off the reflective coating 8 from moisture by means of the ceramic band. Thus, FIGS. 4a-4d show the steps of preparing an outer glass sheet 2 according to the present invention, wherein FIG. 4e shows an assembled automotive window laminate 1 according to an embodiment of the present invention. Below (seen in direction outward to inward) the outer glass sheet 2 a thermoplastic laminated sheet structure 4 is provided. Said thermoplastic laminated sheet structure 4 comprises two bonding layer 6 and a functional film 5 as described in the present application. Optionally, an inward facing surface 3 of the inner glass sheet 3 may also be provided with a ceramic band 9. As such, the connection and frame layer 7 of the thermoplastic laminated sheet structure 4 that are present along the perimeter of the sheet structure 4 may be hidden from sight of a driver. Although this embodiment indicates both an outer glass sheet 2 and inner glass sheet 3, it is conceivable that this is applied to a single glass sheet for use in automotive industry as well. For example on a side window of a vehicle.

The above-described inventive concepts are illustrated by several illustrative embodiments. It is conceivable that individual inventive concepts, including inventive details, may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application and/or alternative embodiment.

The ordinal numbers used in this document, like “first”, “second”, and “third” are used only for identification purposes. Hence, the use of expressions like a “second” component, does therefore not necessarily require the co-presence of a “first” component.

1. An automotive window laminate structure, comprising:
an inner glass sheet, and an outer glass sheet, said inner glass sheet and outer glass sheet situated parallel and mutually spaced apart, the inner glass sheet and outer glass sheet each comprising an inward facing surface and an outward facing surface,
at least one thermoplastic laminated sheet structure, said thermoplastic laminated sheet structure substantially entirely placed between the outward facing surface of the inner glass sheet and the inward facing surface of the outer glass sheet,
at least one reflective coating said reflective coating provided on at least a portion of the inward facing surface of the outer glass sheet,
at least one ceramic band, stretching along at least a portion of the perimeter of the inward facing surface of the outer glass sheet,
wherein the at least one reflective coating and the at least one ceramic band at least partially overlap, and wherein at least a portion of the at least one ceramic band stretches beyond the perimeter of the at least one reflective coating.

2. The automotive window laminate structure according to claim 1, wherein an edge along at least a portion of the perimeter of at least one of the inner glass sheet and/or outer glass sheet is rounded and/or bevelled.

3. The automotive window laminate structure according to claim 2, wherein said rounded and/or bevelled portion is essentially free of reflective coating, and/or wherein the at least one ceramic band at least partially overlaps with said rounded and/or be Med portion.

4. (canceled)

5. The automotive window laminate structure according to claim 1, wherein the laminate structure comprises at least one second ceramic band.

6. The automotive window laminate structure according to claim 5, wherein the second ceramic band is a translucent and/or transparent ceramic band wherein the second ceramic band is at least partially arranged between the at least one ceramic band and the at least one reflective coating.

7. The automotive window laminate structure according to claim 5, wherein the laminate structure comprises at least one third ceramic band.

8. The automotive window laminate structure according to claim 7, wherein the third ceramic band is an opaque ceramic enamel.

9. The automotive window laminate structure according to claim 1, wherein the at least one ceramic band stretches at least its own thickness in length beyond the reflective coating and/or wherein the at least one reflective coating is an infrared and/or heat reflective coating and/or the reflective coating is applied on the entire inward facing surface of the outer glass sheet.

10. (canceled)

11. (canceled)

12. The automotive window laminate structure according to claim 1, wherein the at least one ceramic band stretches beyond the at least one reflective coating along the entire perimeter of the at least one reflective coating.

13. The automotive window laminate structure according to claim 1, wherein the at least one ceramic band seals the at least one reflective coating and/or wherein the at least one reflective coating comprises silver particles.

14. (canceled)

15. The automotive window laminate structure according to claim 1, wherein the at least one ceramic band is a ceramic enamel band, comprising at least one additive chosen from the group consisting of: aluminium, boron, calcium, Gold, lead, lithium, magnesium, silicon, titanium, sodium, Platinum, potassium, tin, oxides, nickel-chromium, iron-oxide, manganese-oxide, chromium-oxides, and/or boron-trioxide.

16. The automotive window laminate structure according to claim 1, wherein the at least one ceramic band has an average total thickness situated between about 10 micron and 60 micron, or about 30 micron.

17. The automotive window laminate structure according to claim 1, wherein the thermoplastic laminated sheet structure comprising;
at least one functional layer, having an upper and lower surface, and;
at least two bonding layers, wherein the at least two bonding layers at least partially cover the upper and lower surfaces of the at least one functional layer.

18. A glass sheet for use in an automotive window laminate according to claim 1.

19. A method for producing an automotive window laminate structure comprising the steps of:
a) providing an inner glass sheet and an outer glass sheet, said inner glass sheet and outer glass sheet each comprising an inward facing surface and an outward facing surface,
b) providing at least one reflective coating onto at least a portion of the inward facing surface of the outer glass sheet,
c) sealing at least a portion of the perimeter of the at least one reflective coating,
d) providing a thermoplastic laminated sheet structure between the inner glass sheet and outer glass sheets.

20. The method according to claim 19, wherein the method comprises a step of:
providing at least one second ceramic band applied onto the at least one reflective coating, wherein said sealing of step c) is sealed by applying the second ceramic band.

21. The method according to claim 20, wherein the method comprises a step of:
providing at least one third ceramic band, applied onto the at least one second ceramic band.

22. The method according to claim 19, wherein during step c), said portion of the perimeter is sealed through step e)
providing at least one ceramic band along at least a portion of the perimeter of the inward facing surface of the outer glass sheet.

23. The method according to claim 20, wherein during step e), at least a part of the at least one ceramic band and/or at least a part of the at least one second ceramic band and/or at least a part of the at least one third ceramic band, overlaps the reflective coating applied during step b), and wherein at least a portion of the at least one ceramic band and/or at least a part of the at least one second ceramic band and/or at least a part of the at least one third ceramic band stretches beyond the perimeter of the at least one reflective coating applied during step b).

24. The method according to claim 19, wherein during step c) the entire perimeter of the at least one reflective coating is sealed and/or wherein the method comprises the step of:
f) providing a bevel and/or rounding on at least a portion of the edge of at least one of the inner glass sheet and/or outer glass sheet.

25. (canceled)
